(19) United States
(12) Patent Application Publication
(10) Pub. No.: US 2026/0240386 A1
(43) Pub. Date: Aug. 20, 2026

(54) CARWASH VACUUM NOZZLE HOLDER

(71) Applicant: James Fitzek, Naples, FL (US)

(72) Inventor: James Fitzek, Naples, FL (US)

(21) Appl. No.: 19/435,917

(22) Filed: Dec. 30, 2025

Related U.S. Application Data
(60) Provisional application No. 63/758,661, filed on Feb. 14, 2025.

(51) Int. Cl. A47L 9/00; A47L 7/00; A47L 9/02; F16M 13/02

(52) U.S. Cl. CPC A47L 9/0009; A47L 7/0076; A47L 9/02; F16M 13/02

(57) ABSTRACT

A vacuum nozzle holder for a carwash vacuum system includes a housing having an opening configured to receive a vacuum nozzle head and a sliding plug assembly movably supported within the housing. The sliding plug assembly is configured to both rotate and translate in response to vacuum pressure generated when the vacuum system is active. Upon insertion of a vacuum nozzle head into the opening, suction causes the plug assembly to rotate into alignment with a vacuum opening of the nozzle head and to translate toward the nozzle head until a sealing plug engages and occludes the vacuum opening. The plug assembly is movable between multiple positions to accommodate variations in nozzle length, geometry, and wear, thereby maintaining effective airflow restriction when the nozzle is parked in the holder.

### CLAIM OF PRIORITY

This is a non-provisional application claiming priority to provisional patent application 63/758,661 filed Feb. 14, 2025.

### FIELD OF INVENTION

The present invention relates to the classification for machines with suction nozzles; and to one or more sub-classifications related to attachments for vacuum cleaners, specifically, a holder for a vacuum nozzle.

### BACKGROUND OF INVENTION

Carwash vacuum systems are widely used in both commercial and self-service environments to remove dirt, debris, and moisture from vehicle interiors. These systems typically include high-suction vacuum units connected to flexible hoses and rigid nozzles that an operator maneuvers within the vehicle. When not in use, the nozzle is commonly stored in a wall- or stand-mounted holder that both parks the nozzle and, in many designs, attempts to restrict airflow into the vacuum line. Restricting airflow when the nozzle is idle is essential for conserving system suction capacity, reducing energy consumption, and preventing unnecessary wear on the vacuum motors.

Existing nozzle holders generally rely on fixed-dimension receptacles or passive seals that assume the nozzle maintains its original size and geometry. However, carwash nozzles routinely experience substantial abrasion and mechanical wear as they are dragged across vehicle carpets, upholstery, and hard interior surfaces. Over time, this wear shortens the nozzle length, alters its profile, and degrades the surfaces that originally interfaced with the holder. Additionally, the geometry of the nozzle holder also degrades. As a result, the nozzle often fails to seat properly in the holder, leaving a persistent gap through which air is drawn into the vacuum system. Even minor gaps can significantly reduce overall suction efficiency, diminish operator performance, and increase the load on the vacuum equipment.

Because wear varies among nozzles and progresses unpredictably, a fixed-geometry holder cannot consistently maintain a reliable seal. Once the nozzle no longer seats correctly, operators frequently resort to makeshift solutions, such as taping or wedging the nozzle in place, or the system is left to run with continuous airflow leakage. Continuous leakage reduces usable suction at the hose during operation, increases noise, elevates energy usage, and accelerates equipment fatigue. Despite these well-recognized issues, conventional holders provide no mechanism for automatically compensating for nozzle wear, no ability to accommodate variations in nozzle length, and no dynamic sealing structure that adjusts in response to vacuum pressure. Accordingly, there remains a need in the field for a nozzle holder capable of maintaining consistent airflow restriction regardless of nozzle wear conditions.

### SUMMARY OF THE INVENTION

This summary is intended to disclose the present invention, a carwash vacuum nozzle holder. The embodiments and descriptions are used to illustrate the invention and its utility and are not intended to limit the invention or its use. The following presents a simplified summary of the primary embodiment of the invention to provide a basic understanding of the invention. Additional concepts that can be added or varied with the primary embodiment are also disclosed. The present invention is novel with respect to the prior art, and can be distinguished from the prior art.

The present invention is comprised of a nozzle holder housing and a sliding plug assembly. The nozzle holder housing is comprised for a base, a top plate, two side plates, and a front plate. The front plate has an opening which is configured to accept a vacuum nozzle. The nozzle holder housing is mounted so that the opening of the front plate is the lowest point on the nozzle holder housing. The rear of the nozzle holder housing can be left open or it can be sealed with a back plate. The two side plates have channels that mate with a guide shaft in the plug assembly.

The plug assembly is comprised of a plug body with an integral sealing plug, a shaft, two shaft guides, and two connectors which attach the shaft guides to the shaft. In the primary embodiment, the shaft guides are washers and the two connectors are threaded fasteners. The plug is comprised of a plug body through which the shaft extends and a sealing plug. The sealing plug is contoured so as to align with the direction of suction from a vacuum nozzle. A The sealing plug can be configured with an air-channel to facilitate such alignment.

The vacuum nozzle holder is configured to receive a carwash vacuum nozzle and to restrict airflow through the vacuum system when the nozzle is not in use. The invention incorporates a nozzle holder housing and sliding plug assembly that accommodate variations in nozzle length and geometry resulting from operational wear. The front plate of the nozzle holder housing has an opening defining a nozzle-receiving region. When not in use, gravity biases the plug assembly towards the opening in the front plate. When a nozzle is inserted into the opening, the vacuum pressure suction creates an air-stream that interacts with the plug assembly. In response to vacuum pressure suction, the plug assembly rotates the sealing plug so that it is aligned with an opening in the vacuum nozzle into which air is sucked. As the sealing plug is rotated to align with the vacuum nozzle opening, the plug assembly linearly translates on a fixed path defined by the channels in the two side plates and the guides on the plug assembly. The plug assembly translates until the sealing plug fully seats to the opening in the vacuum nozzle. This linear mobility enables the sealing plug to reposition itself relative to the nozzle opening as the nozzle wears or as different nozzles are used. Thus, the sealing plug ceases air flow into the vacuum nozzle. This configuration enables the present invention to maintain airflow restriction despite differences in nozzle condition.

The sealing plug is configured to pivot, rotate, or otherwise reorient under the influence of vacuum pressure. In some arrangements, the sealing plug includes a contoured lower surface, an air channel, a counterbalance region, or a shaft connection positioned below the plug's centerline. These structural features may facilitate upward rotation, angular movement, or axial alignment of the plug when vacuum pressure is applied. Such motion assists the plug in positioning itself to occlude the airflow path within the nozzle holder housing and seal the opening in the vacuum nozzle.

In operation, when the vacuum system activates and the nozzle is placed in proximity to or into the holder, airflow may draw the plug toward the nozzle opening. The plug may continue to move until it seats firmly against the nozzle or against a sealing surface of the holder. In some embodiments, the plug's geometry allows the nozzle to capture the plug, lift it, or engage it during placement, further aiding alignment. Upon achieving contact, the plug restricts airflow from the environment into the vacuum line, thereby reducing leakage through the holder.

The nozzle holder housing may incorporate variations and additions of the above listed structural elements. Slots, rails, openings, or other guide features may be formed in the side plates to define the motion path of the chassis. The present invention may also include fastening regions for attachment to a support surface or integration with an existing vacuum-delivery structure.

In some embodiments, the invention also contemplates limiting features or stops that regulate the plug assembly motion. These features may ensure that the plug remains within a functional range of travel and does not over-extend when accommodating a shortened nozzle. Additionally, the invention may include biasing components, such as springs or elastomeric elements, although the system may operate effectively using only vacuum-driven motion without mechanical biasing.

The invention may be implemented in various configurations to accommodate different nozzle styles, vacuum system architectures, and installation environments. The structures described herein may be formed from metals, polymers, composites, or other durable materials suitable for the mechanical and environmental demands of carwash facilities. The invention encompasses all such variations that enable a holder to dynamically adjust to nozzle wear, permit plug movement under vacuum pressure, and maintain airflow restriction when the nozzle is parked in the holder.

### BRIEF DESCRIPTION OF THE DRAWINGS

The present invention is illustrated with 7 drawings on 9 sheets. FIG. 1 is a perspective view of an example vacuum nozzle used in a carwash, suitable for placement within the present invention, a carwash vacuum nozzle holder.

FIG. 2A is a perspective view of an embodiment of a nozzle holder showing the nozzle holder housing in a first position relative to the vacuum nozzle. FIG. 2B is a perspective view of the nozzle holder housing of FIG. 2A showing the nozzle fully inserted into the nozzle holder.

FIG. 3A is a top view of an example nozzle holder showing a sliding plug assembly positioned relative to a vacuum nozzle head. FIG. 3B is a top view of the nozzle holder of FIG. 3A showing the sliding plug assembly oriented in a forward position and partially engaged with the nozzle head. FIG. 3C is a top view of the nozzle holder of FIGS. 3A-3B showing the sliding plug assembly fully seated into the nozzle head, sealing the nozzle head.

FIG. 4 is a top view of an alternative embodiment of a nozzle holder illustrating structural features of the nozzle holder housing and sliding plug assembly.

FIG. 5A is an isolation perspective view of an embodiment of the sliding plug assembly for use within the nozzle holder housing. FIG. 5B is a perspective view of a plug body with sealing plug.

FIG. 6 is a perspective view of an embodiment of the nozzle holder housing showing guide slots and mounting structures.

FIG. 7 is a perspective view showing the carwash vacuum nozzle holder mounted in use with the vacuum nozzle positioned within the opening.

### DESCRIPTION OF THE DRAWINGS

The following descriptions are not meant to limit the invention, but rather to add to the provisional summary of invention, and illustrate the present invention, a carwash vacuum nozzle holder. The present invention is illustrated with a variety of drawings showing the primary embodiment of the present invention, with examples presented showing various stages of an accessible virtual tour.

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

The present invention 100 relates to a vacuum nozzle holder configured to receive and retain a standard carwash vacuum nozzle head 10 when the vacuum system is not in use. As shown in FIG. 1, a typical carwash vacuum nozzle 1 includes nozzle head 10, an elongated tubular body 12, a connector region 11, a hose header 14 integral with a flexible vacuum hose 15. The distal nozzle tip defines a vacuum opening 16 configured to contact automotive interior surfaces during vacuuming. The connector region 11 securely fastens the elongated tubular body 12 to the hose header 14 without pressure loss.

Conventional carwash vacuum nozzles 1 rest in a holder when not in use. A typical carwash vacuum nozzle holder (not shown) has a surface such as foam or carpet intended to seal against the vacuum opening 16. Repeated contact with vehicle interiors so as to vacuum the vehicle interior will cause the nozzle head 10 in proximity to the vacuum opening 16 to wear. Repeated contact with the vacuum nozzle holder also causes the nozzle head 10 to wear due to constant friction. A typical vacuum nozzle holder will also wear due to friction over the course of time. This wear will alter the dimensions of the vacuum opening 16 and the size and shape of the nozzle head 10. Combined, over time, the vacuum nozzle holder loses its ability to seal against the vacuum opening 16, resulting in wear and tear on the vacuum system, increased energy costs, noise, and decreased suction.

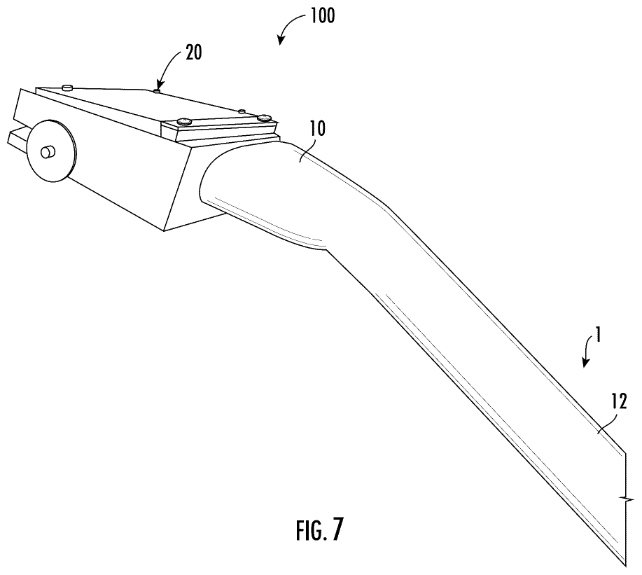

The disclosed nozzle holder 100 (see FIG. 7) is configured to adapt automatically to varying nozzle head 10 and vacuum opening 16 geometries and wear states, thereby maintaining an effective seal against the nozzle head 10 and vacuum opening 16 using the vacuum's suction.

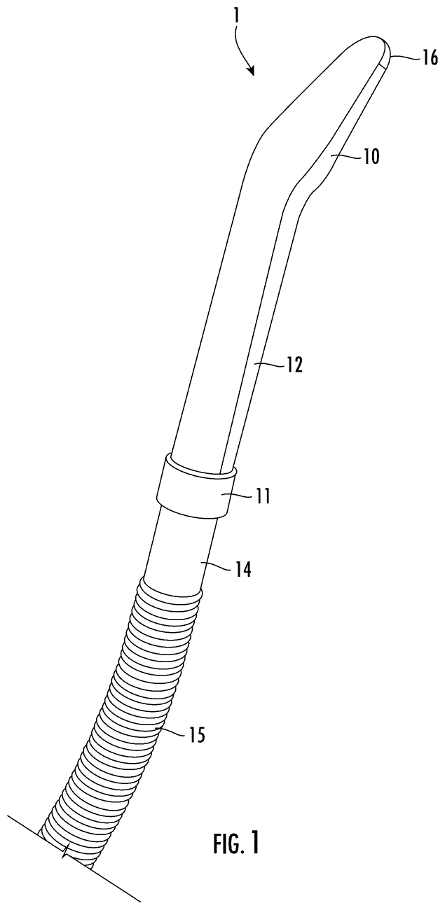

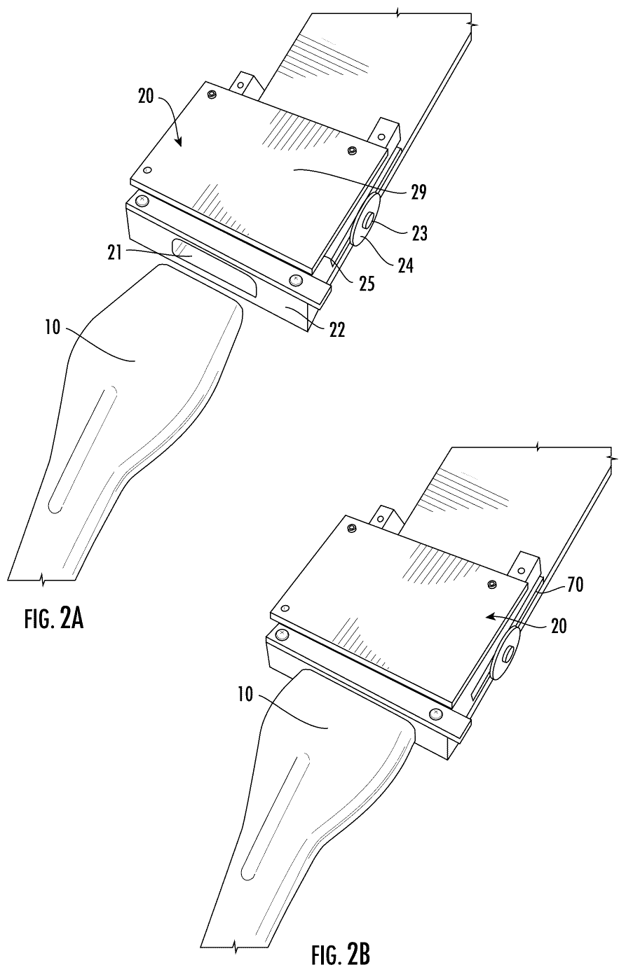

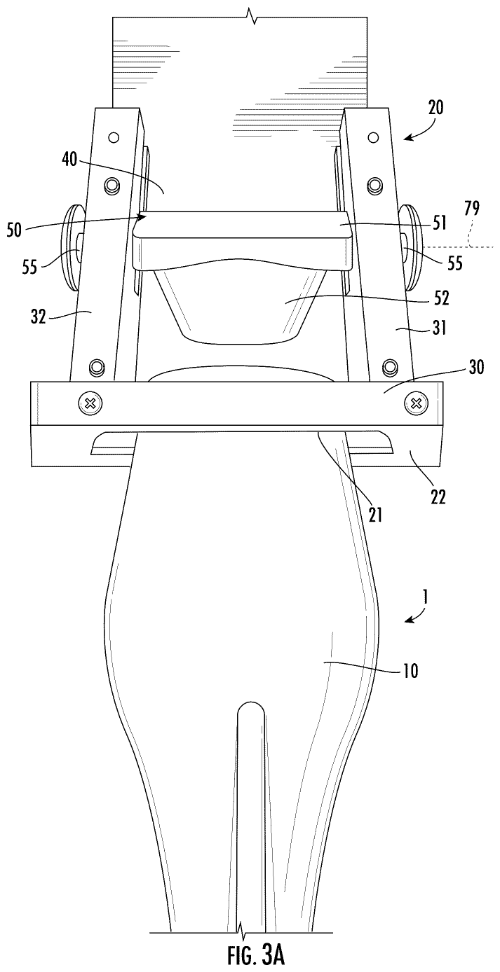

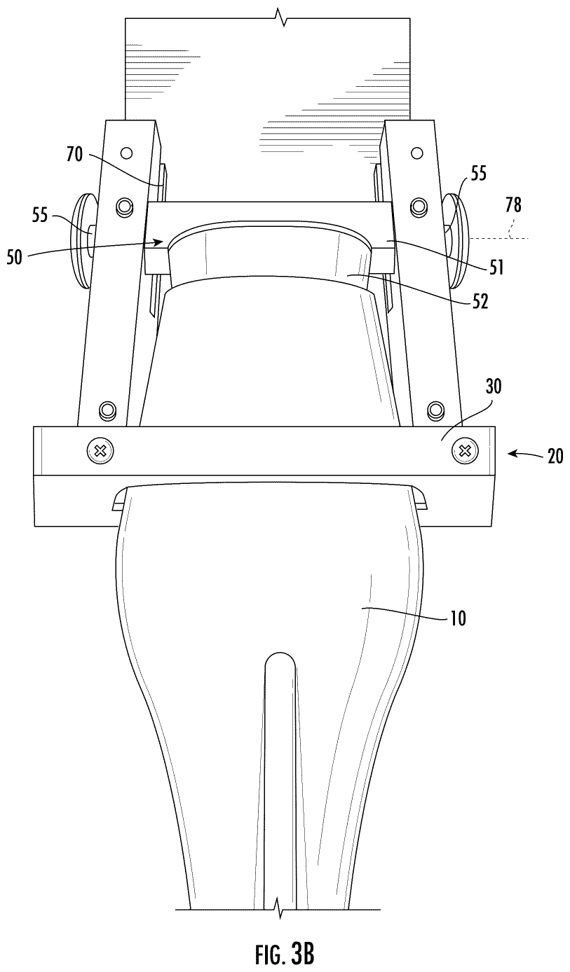

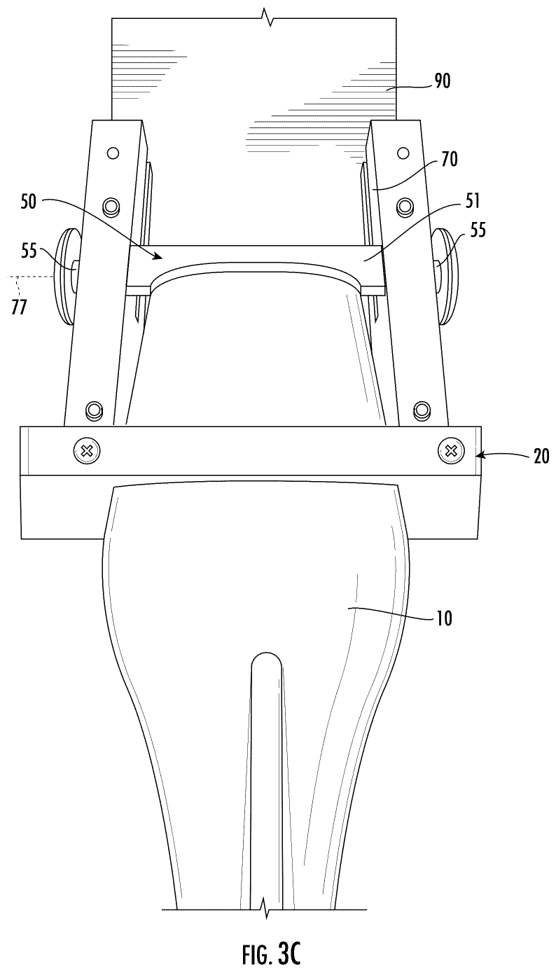

As shown in FIGS. 2A, 2B, 3A, 3B, and 3C the nozzle holder housing 20 is comprised of a front plate 22 with an opening 21, the opening 21 being sized and shaped to receive at least a portion of the nozzle head 10; a top plate 29; a first side plate 25, 31, a second side plate 32, and a base 90. An optional back plate can be added to the nozzle holder housing 20, but is not necessary. The nozzle holder housing 20 as disclosed is only partially enclosed, as there is an opening for the nozzle head 10 and there is no back plate. The opening 21 is configured such that its inner boundary generally conforms to the outer contour of the nozzle head 10, whether the nozzle 1 is new or partially worn. The nozzle holder housing 20 is mounted so that the opening 21 is the lowest point of the nozzle holder housing 20.

The top plate 22 is attached to the top surface 30 of the front plate 22 and the top surfaces 31, 32 of each of the two side plates 31, 32. Removing the top plate 22 exposes the internal structure of the holder. The nozzle holder housing 20 includes a first side plate 31 and a second side plate 32 extending longitudinally toward the rear of the nozzle holder housing. The front plate 22, the first side plate 31 and the second side plate 32 are all attached to the top surface 40 of the base 90. Each side plate 31, 32 is fabricated with features, 23, 24, 70 intended to position the sliding plug assembly 50.

In the embodiment shown in FIGS. 3A-3C, the guides consist of slots 70 that position a shaft 55 of a sliding plug assembly, 50, the shaft having two ends. Each end of the shaft terminates in a washer 24 and threaded fastener 23. The slots 70 are fabricated into the side of each side plate 31, 32. The slots 70 guide the shaft 55 of a sliding plug assembly 50. The sliding plug assembly can linearly translate forward and backward within the nozzle holder housing 20 along the slots 70. The sliding plug assembly 50 has a plug body 51 with an integral sealing plug 52.

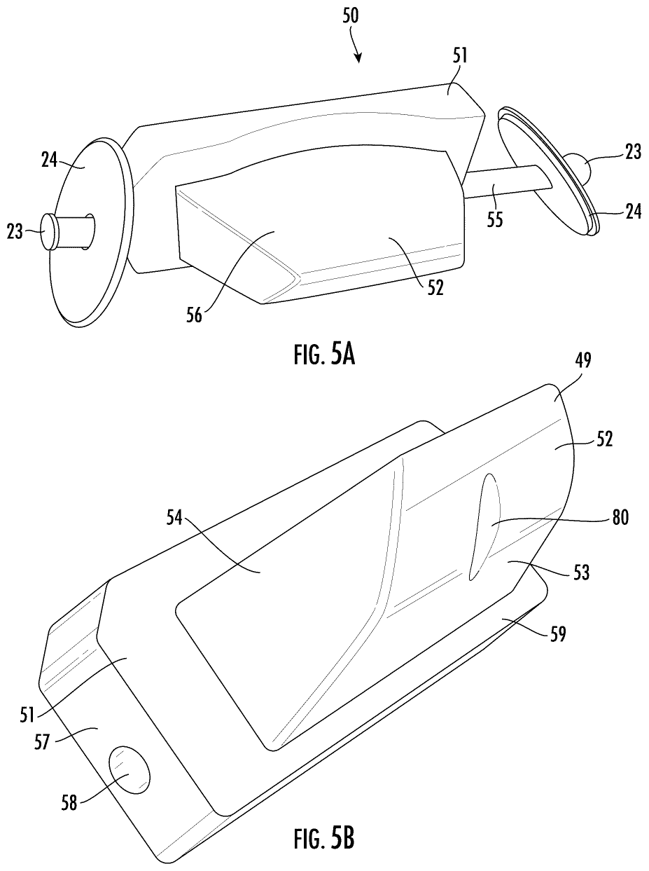

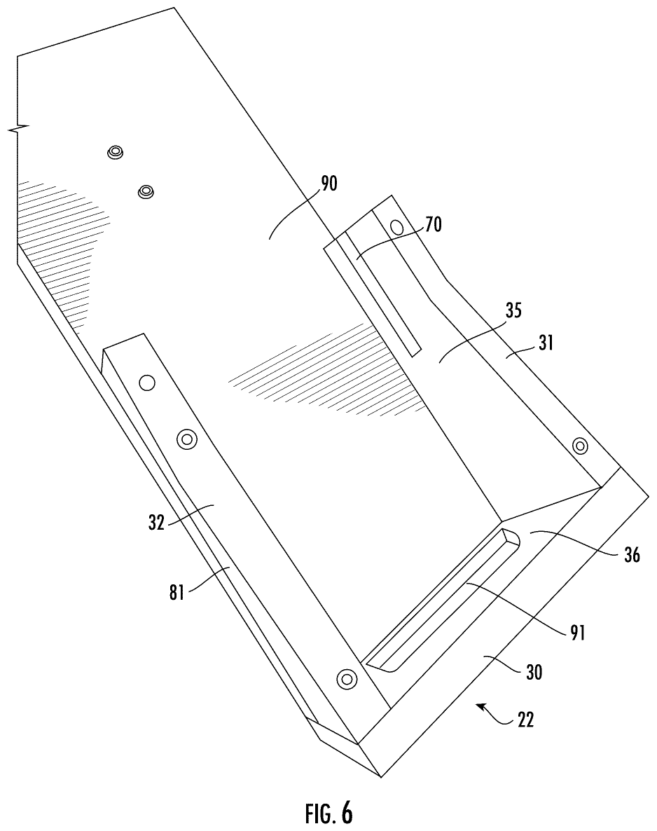

An isolation of the nozzle holder housing 20 with its top plate 29 removed is shown in FIG. 6. The top surface 30 of the front plate 22 is visible. The first side plate 31 has an inner surface 35. The outer surface 81 of the second side plate 32 is also visible. The interior 91 of the opening 21 in the front plate 22 is visible in this view, as is the interior surface 36 of the front plate 22. Also shown are the base 90 and the slot 70 in the first side plate 31.

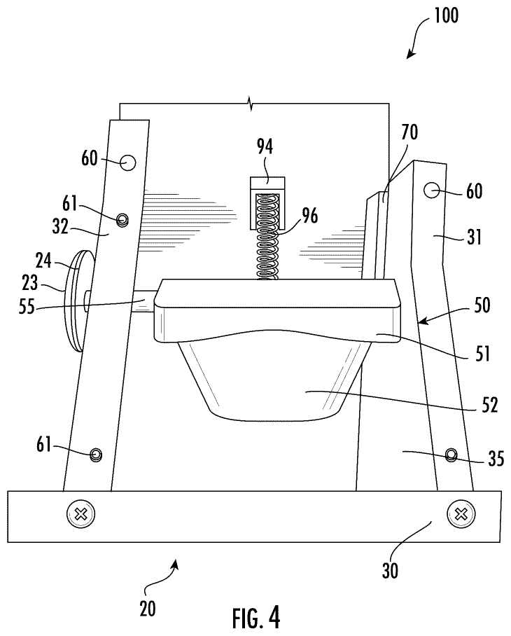

An isolation of the sliding plug assembly 50 is shown in FIGS. 5A and 5B. The integral sealing plug 52 has an upper surface 56, a first side surfaces 54, a second side surface (not shown, but a mirror image of 54), a lower contoured surface 53, and a beveled leading edge 49. An optional air-flow channel 80 can be added to the contoured surface 53, enabling controlled air flow across the plug surface to facilitate its rotation in response to vacuum pressure suction. The air-flow channel 80 is distal from the axis of rotation of the plug body 51 about the shaft 55.

The plug body 51 has an interior surface 59 that terminates at the integral sealing plug 52. The plug body 51 has first side surface 57 (visible in FIG. 5B) and a second side surface (not shown), which are mirrored images of one another. A through-hole 58 extends from the first side surface 57 to the second side surface. A shaft 55 extends through the through-hole 58. Each end of the shaft 55 terminates in a washer 24 and threaded fastener 23.

When a vacuum system is active and a vacuum nozzle head 10 is inserted into the opening 21, the vacuum pressure suction force causes an air-flow direction within the vacuum holder housing 20 and acts upon the sliding plug assembly 50. The vacuum pressure suction causes the plug body 51 and integral sealing plug 52 to rotate about the shaft 55 so that the beveled leading edge is aligned with the vacuum opening 16 of the nozzle head 10. The sliding plug assembly 50 is free to translate along the slots 70.

This movement is illustrated in FIGS. 3A-3C, which show the sliding plug assembly 50 in various positions 77, 78, 79 relative to the nozzle head 10. In FIG. 3A, the sliding plug assembly 50 is in a first position 79 with respect to the nozzle head 10. The nozzle head 10 has just entered the opening 21. The vacuum pressure suction of the nozzle opening 16 has just begun to make air flow within the nozzle holder housing 20. The sliding plug assembly 50 has not yet rotated or linearly translated towards the nozzle head 10. In FIG. 3B, the sliding plug assembly is in a second position 78 with respect to the nozzle head 10. The integral sealing plug 52 of the sliding plug assembly 50 has partially entered the vacuum opening 16 of the nozzle head 10. In FIG. 3C, the sliding plug assembly is in a third position 77 with respect to the nozzle head 10. The integral sealing plug 52 is fully inserted into the vacuum opening 16 of the nozzle head 10, sealing the nozzle head 10.

FIG. 4 shows an alternative embodiment of the present invention 100. Standard elements of the nozzle holder housing 20 are visible: the top surface 30 of the front plate, the first side plate 31, the second side plate 32, the slot 70 in the side plate 31. From this perspective, the inner surface 35 of the first side plate 31 is visible, as are a variety of threaded fastener holes 60, 61. Standard elements of the sliding plug assembly 50 are also visible: the plug body 51, the integral sealing plug 52, the shaft 55, the washer 24, and the threaded fastener 23. In this alternative embodiment, a spring 96 connects the plug body 51 to a spring mount 94. When there is no vacuum nozzle head 10 present in the nozzle holder housing 20, the spring 96 returns the sliding plug assembly 50 to an initial position 79.

FIG. 7 depicts the vacuum nozzle 10 inserted into the vacuum nozzle housing 20. The opening 21 of the vacuum nozzle housing 20 is the lowest point of the vacuum nozzle housing 20. In other words, the opening 21 is angled downward. When not in use, this orientation causes gravity to bias the sliding plug assembly 50 towards the opening 21. In use, the vacuum nozzle 10 is inserted into the opening 21 of the holder 20. The nozzle head 10 engages the contoured receiving region of the opening while the sliding plug assembly 50 rotates and linearly translates so as to insert the integral sealing plug 52 into the vacuum opening 16 of the nozzle head 10. When suction is generated by the vacuum system, the beveled leading edge 49 of the integral sealing plug 52 enters the vacuum opening 16. Suction continues to draw in the integral sealing plug 52 until it is tightly sealed to the nozzle head 10, thereby preventing vacuum pressure from escaping through the carwash vacuum nozzle holder 100. As the nozzle head 10 becomes worn and shortens with continued use, the sliding plug assembly 50 is still able to achieve sealing engagement with the nozzle head 10, by sliding along the slots 70 until it is in sealing engagement with the nozzle head 10.

This self-adjusting behavior ensures that the present invention 100 remains effective over the service life of multiple nozzle heads 10 exhibiting different wear patterns. By accommodating variations in length, contour, and surface condition, the carwash vacuum nozzle holder 100 reduces suction loss, energy consumption, noise, and equipment wear.

I claim:

1. A vacuum nozzle holder comprising:
a nozzle holder housing defining a partially enclosed interior with an opening configured to receive a vacuum nozzle head;
a pair of spaced guides disposed within the nozzle holder housing; and
a sliding plug assembly movably supported by the pair of spaced guides,
wherein the sliding plug assembly is configured to linearly translate along the guides between a forward position and a rearward position in response to the vacuum pressure suction created by the insertion of the vacuum nozzle head into the opening, and
wherein the sliding plug assembly is further configured to move into sealing engagement by rotating and translating in response to vacuum pressure suction caused by the insertion of a vacuum nozzle head into the opening of the nozzle holder housing.

2. The vacuum nozzle holder of claim 1, wherein the sliding plug assembly is comprised of a plug body, an integral sealing plug permanently affixed to the plug body, and a shaft.

3. The vacuum nozzle holder of claim 2, wherein the plug body is rotatably mounted to the shaft.

4. The vacuum nozzle holder of claim 3, wherein the plug body and integral sealing plug are configured so as to rotate into alignment with a vacuum opening of the vacuum nozzle head when suction is applied.

5. The vacuum nozzle holder of claim 4, wherein the plug body and integral sealing plug rotate in response to suction from the vacuum opening so that the beveled leading edge of the integral sealing plug aligns with the vacuum opening so as to enter the vacuum opening.

6. The vacuum nozzle holder of claim 5, wherein the integral sealing plug has a contoured underside with an air-flow channel, positioned distal from the axis of rotation of the plug body.

7. The vacuum nozzle holder of claim 6, wherein the nozzle holder housing is comprised of a top plate, a front plate with an opening, two side plates, and a base, and wherein each of the two side plates has a slot, distal to the front plate.

8. The vacuum nozzle holder of claim 7, wherein the opening of the front plate is contoured to correspond generally to a head of the vacuum nozzle.

9. The vacuum nozzle holder of claim 8, wherein the nozzle holder house is mounted so that the opening of the front plate is at the lowest point of the nozzle holder housing.

10. The vacuum nozzle holder of claim 9, wherein the shaft extends between the slot of the first side plate and the slot of the second side plate.

11. The vacuum nozzle holder of claim 10, wherein the shaft can translate along the slots of the two side plates between the forward position and the rearward position.

12. The vacuum nozzle holder of claim 11, wherein the nozzle holder housing is angled downward so that gravity causes the sliding plug assembly to be biased towards the opening.

13. The vacuum nozzle holder of claim 12, further comprising a biasing element that returns the sliding plug assembly to an initial position when the nozzle head is removed from the nozzle holder housing.

14. The vacuum nozzle holder of claim 13, wherein the biasing element is a spring.

15. The vacuum nozzle holder of claim 14, wherein the spring attaches the sliding plug assembly to a spring mount.

16. A method of sealing a vacuum nozzle when not in use, comprising:
inserting a vacuum nozzle into an opening of a vacuum nozzle holder having a sliding plug assembly;
rotating the sliding plug assembly so that an integral sealing plug is aligned with a vacuum opening in the vacuum nozzle;
translating the sliding plug assembly towards the vacuum nozzle in response to suction provided by the vacuum nozzle;
sealing the vacuum opening in the vacuum nozzle with the integral sealing plug in response to suction provided by the vacuum nozzle.

17. The method of claim 16, wherein rotating and translating the sliding plug assembly compensates for wear-related shortening of the vacuum nozzle.

18. The method of claim 17, wherein the beveled leading edge of the integral sealing plug is configured to engage the vacuum nozzle.

19. The method of claim 16, wherein the step of inserting the vacuum nozzle includes seating the vacuum nozzle in a contoured opening of the nozzle holder housing.

20. The method of claim 16, wherein the nozzle holder housing is mounted so that gravity biases the sliding plug assembly towards the contoured opening of the nozzle holder housing.
